(19) United States
(12) Patent Application Publication
(10) Pub. No.: US 2022/0046339 A1
(43) Pub. Date: Feb. 10, 2022

(54) DATA COLLECTION DEVICE, DATA COLLECTION METHOD, AND PROGRAM

(71) Applicant: Mitsubishi Electric Corporation, Tokyo (JP)

(72) Inventor: Osamu NASU, Tokyo (JP)

(73) Assignee: Mitsubishi Electric Corporation, Tokyo (JP)

(21) Appl. No.: 17/428,284

(22) PCT Filed: Apr. 25, 2019
(86) PCT No.: PCT/JP2019/017810

§ 371 Date: Aug. 4, 2021

(51) Int. Cl. H04Q 9/00

(52) U.S. Cl. CPC H04Q 9/00

(57) ABSTRACT

A data collection apparatus (10) is connectable to a device (21) and includes a process setting unit (141), a collector (160), and a process controller (143). The process setting unit (141) receives and sets a parameter for data collection. The collector (160) collects data from the device (21) in accordance with the parameter set by the process setting unit (141). The process controller (143) outputs the data collected by the collector (160) to a processing unit (130) to cause the processing unit (130) to process the data. The collector (160) determines whether the parameter received by the process setting unit (141) satisfies a predetermined condition and provides a determination result to the process setting unit (141). The process setting unit (141) outputs result information corresponding to the determination result provided by the collector (160).

### TECHNICAL FIELD

The present disclosure relates to a data collection apparatus, a data collection method, and a program.

### BACKGROUND ART

Production, inspection, and various other processes performed at facilities, typically factories, commonly involve processing of data collected in real time from the facilities (see, for example, Patent Literature 1).

Patent Literature 1 describes a data collection apparatus that collects data from programmable logic controllers (PLCs) through a control network and transmits the collected data to a host computer through an information network. This apparatus allows data collected from the PLCs to be processed at the host computer.

### CITATION LIST

### Patent Literature

Patent Literature 1: Unexamined Japanese Patent Application Publication No. 2007-80286

### SUMMARY OF INVENTION

### Technical Problem

When collecting data output from devices through different networks, the apparatus may use different collection processes designed specifically for different networks or devices as data collection targets. The collection processes are defined using different types of parameters with different allowable ranges depending on types of the networks or devices as collection targets. The data collection apparatus may include an interface for receiving such parameters to avoid any complicated workload for the user referring to the specifications of each collection target for setting parameters with the apparatus in designing a collection process for each collection target.

For user convenience, the apparatus may have a common setting tool as a user interface for setting parameters for multiple collection targets. A common setting tool may have predefined parameter configurations for collection targets and may have an interface prepared for receiving input of parameters for each data collection target.

As described above, the types of parameters to be set and the conditions to be satisfied by the parameters are different for different collection targets. A parameter input as a setting value for a collection target is to be determined as to whether the parameter satisfies the condition for the collection target. However, the condition to be satisfied by the parameter may include a logic specific to the collection target. For example, for a new collection target to be added, the setting tool cannot preinstall an interface that can determine whether the parameter satisfies the condition. Thus, the data collection apparatus cannot easily incorporate the function of collecting data from a new collection target.

In response to the above issue, an objective of the present disclosure is to enable an apparatus for data collection to easily incorporate a function of collecting data from a new collection target.

### Solution to Problem

To achieve the above objective, a data collection apparatus according to an aspect of the present disclosure is connectable to a device. The data collection apparatus includes setting means for receiving and setting a parameter for data collection, collection means for collecting data from the device in accordance with the parameter set by the setting means, and control means for outputting the data collected by the collection means to processing means to cause the processing means to process the data. The collection means determines whether the parameter received by the setting means satisfies a predetermined condition and provides a determination result to the setting means. The setting means outputs result information corresponding to the determination result provided by the collection means.

### Advantageous Effects of Invention

In the data collection apparatus according to the above aspect of the present disclosure, the collection means for collecting data determines whether a parameter satisfies a predetermined condition and provides the determination result to the setting means. The setting means outputs result information corresponding to the determination result. Thus, the setting means receiving the parameter outputs result information based on the determination result without determining whether the parameter satisfies the condition. When any new data collection target is added, the collection means is changed or added for the new collection target without the setting means being changed. Thus, the data collection apparatus can easily incorporate a function of collecting data from a new collection target.

### BRIEF DESCRIPTION OF DRAWINGS

FIG. 1 is a block diagram of a data processing system according to an embodiment of the present disclosure;

FIG. 2 is a hardware diagram of a data collection apparatus according to the embodiment;

FIG. 3 is a diagram showing the setting of an example process sequence in the embodiment;

FIG. 4 is a functional block diagram of the data collection apparatus according to the embodiment;

FIG. 5 is a diagram of a storage in an implementation controller in the embodiment, showing information stored in the storage;

FIG. 6 is a diagram describing the formats of parameters in the embodiment;

FIG. 7 is a diagram of a storage in a collector in the embodiment, showing information stored in the storage;

FIG. 8 is a flowchart showing setting in the embodiment;

FIG. 9 is a diagram showing a first example of an input screen in the embodiment;

FIG. 10 is a diagram showing a second example of the input screen in the embodiment;

FIG. 11 is a diagram showing a third example of the input screen in the embodiment;

FIG. 12 is a diagram showing a fourth example of the input screen in the embodiment;

FIG. 13 is a diagram showing a fifth example of the input screen in the embodiment;

FIG. 14 is a diagram showing a sixth example of the input screen in the embodiment;

FIG. 15 is a diagram showing a seventh example of the input screen in the embodiment;

FIG. 16 is a diagram showing an eighth example of the input screen in the embodiment;

FIG. 17 is a flowchart showing process implementation in the embodiment;

FIG. 18 is a flowchart showing event information display in the embodiment;

FIG. 19 is a block diagram of a data collection apparatus in a modification; and

FIG. 20 is a diagram showing a process sequence in the modification.

### DESCRIPTION OF EMBODIMENTS

A data collection apparatus 10 according to embodiments of the present disclosure will now be described in detail with reference to the drawings.

### Embodiments

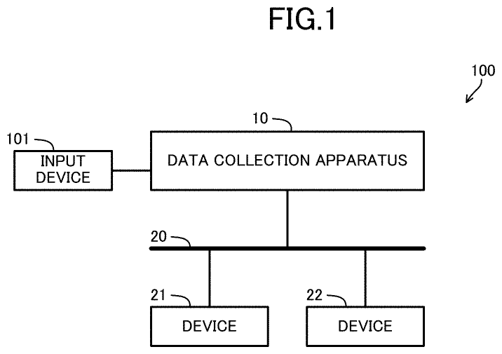

The data collection apparatus 10 according to the present embodiment is, for example, an industrial personal computer (IPC) installed at a factory. As shown in FIG. 1, the data collection apparatus 10 is connected to devices 21 and 22 on a production line in a factory through an industrial network 20. The data collection apparatus 10 is also connected to an input device 101 for receiving input of the setting value of a parameter about data collection. The data collection apparatus 10, the input device 101, and the devices 21 and 22 form a data processing system 100 as a factory automation (FA) system. In the example described below, the data collection apparatus 10 processes data collected from the device 21 through the network 20, and outputs a control instruction corresponding to the processing result to the device 22. The device 21 is a sensor. The device 22 is an actuator or a robot. The devices 21 and 22 may be any other devices.

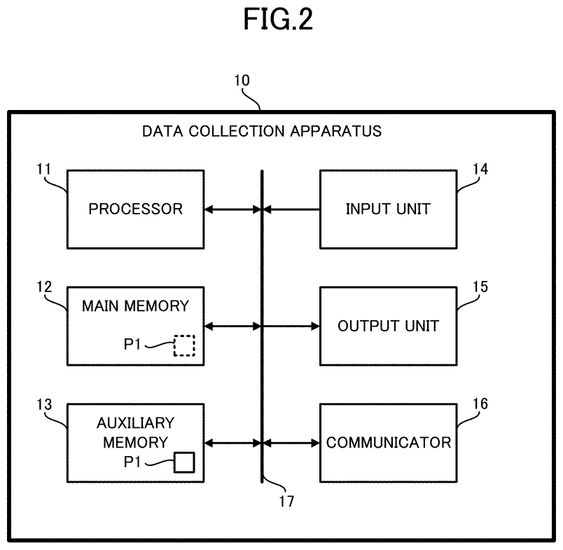

As shown in FIG. 2, the data collection apparatus 10 includes, as hardware components, a processor 11, a main memory 12, an auxiliary memory 13, an input unit 14, an output unit 15, and a communicator 16. The main memory 12, the auxiliary memory 13, the input unit 14, the output unit 15, and the communicator 16 are all connected to the processor 11 with an internal bus 17.

The processor 11 includes a central processing unit (CPU). The processor 11 executes a program P1 stored in the auxiliary memory 13 to implement the various functions of the data collection apparatus 10 and perform the processing described later.

The main memory 12 includes a random-access memory (RAM). The main memory 12 stores the program P1 loaded from the auxiliary memory 13. The main memory 12 is used as a work area by the processor 11.

The auxiliary memory 13 includes a non-volatile memory, typically an electrically erasable programmable read-only memory (EEPROM) and a hard disk drive (HDD). The auxiliary memory 13 stores, in addition to the program P1, various data items used in the processing performed by the processor 11. The auxiliary memory 13 provides data usable by the processor 11 to the processor 11 as instructed by the processor 11, and stores data provided by the processor 11. Although FIG. 2 shows the typical single program P1, multiple programs may be stored in the auxiliary memory 13 or loaded into the main memory 12.

The input unit 14 includes input devices, typically input keys and a pointing device. The input unit 14 acquires information input by the user of the data collection apparatus 10 and provides the acquired information to the processor 11.

The output unit 15 includes output devices, typically a liquid crystal display (LCD) and a speaker. The output unit 15 presents various items of information to the user as instructed by the processor 11.

The communicator 16 includes a network interface circuit for communicating with external devices. The communicator 16 receives a signal from an external device and outputs data carried by the signal to the processor 11. The communicator 16 also transmits a signal carrying data output from the processor 11 to an external device.

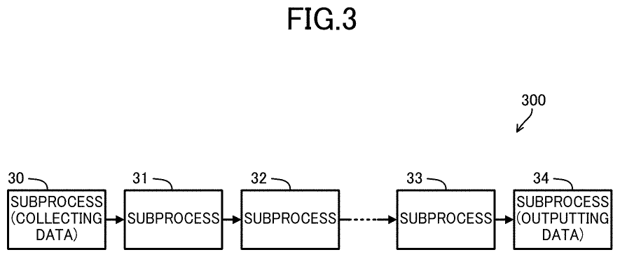

With the hardware components shown in FIG. 2 operating in cooperation, the data collection apparatus 10 implements various functions including processing of data. The processing of data to be performed by the data collection apparatus 10 is defined by the user in any manner in a process sequence 300. The process sequence 300 includes a series of subprocesses 30, 31, 32, 33 and 34 that are sequentially performed as illustrated in FIG. 3.

The process sequence 300 includes subprocesses that are sequentially performed on data output from the device 21. In detail, the process sequence 300 includes the subprocess 30 for collecting data to undergo the process sequence 300, the subprocesses 31 to 33, and the subprocess 34 for outputting data indicating the result of the process sequence 300 that are performed in this order. The arrows in FIG. 3 indicate the transfer of data to undergo the subprocesses. For example, the subprocess 30 is performed to acquire data from a device external to the data collection apparatus 10. The data is input into the subprocess 31. The data thus undergoes the subprocess 31. Data indicating the processing result of the subprocess 31 is output from the subprocess 31 to the subprocess 32. The data thus undergoes the subprocess 32. Data indicating the processing result of the subprocess 33 is output from the subprocess 33 to the subprocess 34. The data thus undergoes the subprocess 34 and is output from the data collection apparatus 10 to an external device.

The subprocess 30 corresponds to a process for receiving a signal from the device 21 through the network 20 shown in FIG. 1 to collect data. The subprocess 30 is periodically performed in accordance with preset parameters to monitor the sensing results transmitted from the device 21. The subprocess 30 is performed at intervals of, for example, 10 ms, 100 ms, or 1 s. The data indicating the sensing result is a digital value of, for example, 8 or 16 bits.

The subprocesses 31 to 33 are performed repeatedly as the subprocess 30 is performed. For example, the subprocess 31 calculates a moving average, the subprocess 32 determines whether the value to be processed exceeds a predetermined threshold, and the subprocess 33 determines the details of a control instruction for the device 22 in FIG. 1. Through these subprocesses 31 to 33, the sensing result from which noise is removed is generated using the moving average, and a predetermined control instruction is output when the resultant value exceeds the threshold.

The subprocesses 31 to 33 are not limited to the above processes. For example, the subprocesses 31 to 33 may be rounding or normalization for converting a value to fall within a predetermined range, scaling for multiplying an input value by a predetermined constant, shifting for adding a predetermined offset value to an input value, filtering or statistical processing other than calculating a moving average, or transformation, typically a fast Fourier transform (FFT). The subprocesses 31 to 33 may be any other manipulation or diagnosis, or any other processes.

The subprocess 34 corresponds to transmission of the processing result of the subprocess 33 to the device 22 through the network 20 shown in FIG. 1. However, the subprocess 34 is not limited to transmission of data to the device 22, but may be output of an instruction for executing a preliminarily specified program, display of the result of the process sequence 300 on a screen, transmission of information to another device, or any other output. In the example described below, data generated through the process sequence 300 is output to the device 22 as a control instruction.

The subprocesses 30 to 34 are performed in series on repeatedly input data. For example, the subprocesses 30 to 34 are sequentially performed on first data collected from the device 21, and are sequentially performed on second data collected next. The subprocesses 30 to 34 are performed on the first data and the second data in parallel. In other words, a process sequence on the second data starts before the completion of the process sequence on the first data. However, the process sequences may be performed in series rather than in parallel. Although FIG. 3 shows the process sequence 300 including the five subprocesses 30 to 34, the process sequence 300 may include four or less or six or more subprocesses.

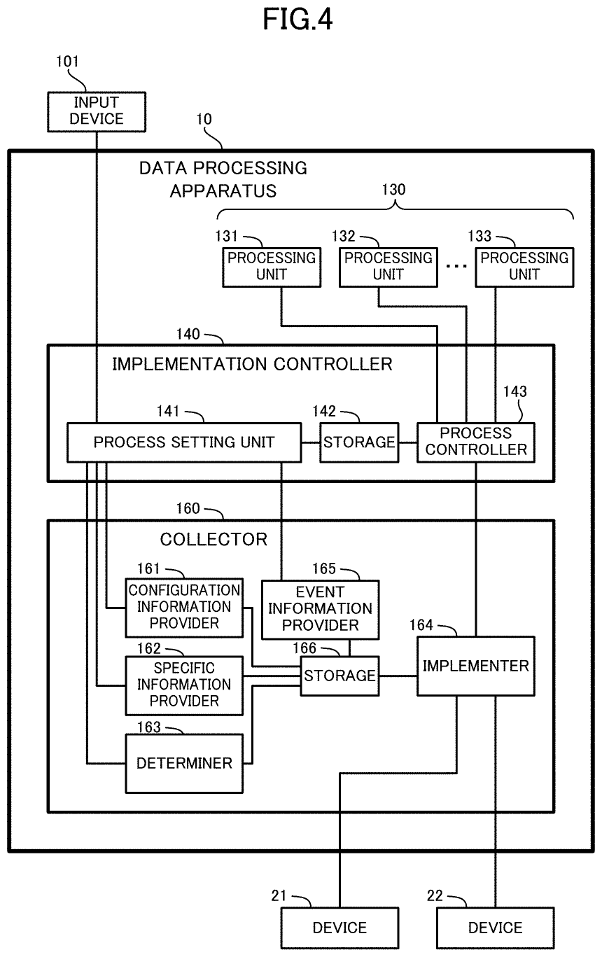

The data collection apparatus 10 includes the functional components as shown in FIG. 4 to perform the process sequence 300 shown in FIG. 3. In detail, the data collection apparatus 10 includes processing units 131, 132, and 133 for performing subprocesses, an implementation controller 140 for controlling the implementation of the process sequence, and a collector 160 for collecting data and outputting a control instruction.

The processing units 131 to 133 are implemented mainly by the processor 11 and the main memory 12 operating in cooperation, and perform the subprocesses 31 to 33. In detail, each of the processing units 131 to 133 is implemented by the processor 11 running a software module stored in the auxiliary memory 13. The software module may be plug-in software stored in the auxiliary memory 13 by the user. The plug-in software may be designed, purchased, or acquired as open-source software by the user. The processing units 131 to 133 are hereafter collectively referred to as processing units 130. The processing units 130 are examples of processing means for processing data in the data collection apparatus 10.

The processing units 130 may not correspond one-to-one to the subprocesses included in the process sequence 300 shown in FIG. 3. In some embodiments, a subprocess may be performed on data twice in a row. Such two subprocesses may be combined and performed by a single processing unit 130 in the process sequence 300.

The implementation controller 140 is implemented mainly by the processor 11, the main memory 12, and the communicator 16 operating in cooperation. The implementation controller 140 receives the setting of a process sequence from the input device 101. The implementation controller 140 relays data between a processing unit 130 and another processing unit 130 and between a processing unit 130 and the collector 160. The implementation controller 140 thus causes the processing units 130 and the collector 160 to perform subprocesses in the order corresponding to the set process sequence. The implementation controller 140 includes a process setting unit 141 for receiving, from the input device 101, a parameter that defines a process sequence to set the received parameter, a storage 142 for storing various items of information including the setting of a process sequence, and a process controller 143 for determining a subprocess to be performed on data based on the setting of the process sequence to control the data sequence.

The process setting unit 141 exchanges information with the input device 101 to allow the input device 101 to serve as a graphical user interface (GUI). In detail, the process setting unit 141 provides data to the input device 101 to display an input screen for receiving input of the setting of a process sequence. The process setting unit 141 thus acquires from the input device 101 a setting input into the input screen. In more detail, the process setting unit 141 acquires configuration information for creating an input screen from the collector 160 and provides the configuration information to the input device 101. The configuration information includes, for example, the types and sizes of objects to appear on an input screen, character strings to appear on an input screen, and information defining the transition of an input screen. The input device 101 creates an input screen for display based on the configuration information. The process setting unit 141 also receives from the input device 101 a parameter input into the input device 101 by the user. The parameter includes values for data collection defining, for example, the types, the implementation order, and the details of subprocesses included in a process sequence. The input device 101 corresponds to an example of input means for receiving input of the setting about data collection.

The process setting unit 141 also inquires of the collector 160 whether the received parameter satisfies a predetermined condition, and acquires the determination result from the collector 160. When the received parameter does not satisfy the condition, the process setting unit 141 outputs, to the input device 101, information for prompting the user to re-input a parameter as result information indicating the determination result. The process setting unit 141 receives from the input device 101 a parameter re-input by the user.

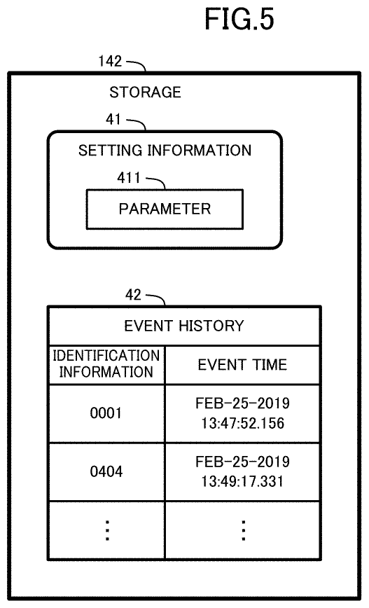

The process setting unit 141 sets the received parameter. In detail, the process setting unit 141 writes setting information indicating the parameter onto the storage 142. The storage 142 stores setting information 41 including a parameter 411 as shown in FIG. 5. The process setting unit 141 corresponds to an example of setting means for setting a received parameter in the data collection apparatus 10. The storage 142 corresponds to an example of storage means for storing setting information in the data collection apparatus 10.

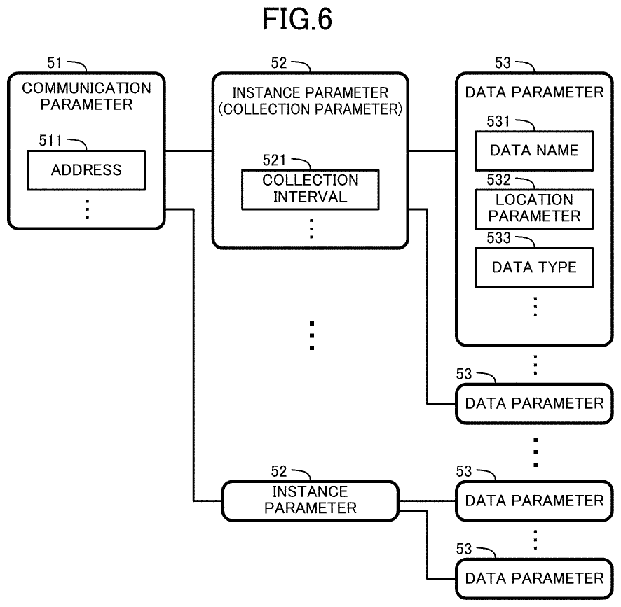

The parameter is defined in various formats. FIG. 6 illustrates parameters about data collection performed by the collector 160. A communication parameter 51 shown in FIG. 6 is used to identify the device 21 as a data collection target. The communication parameter 51 includes an address 511 of the device 21. The communication parameter 51 may include the address 511 and another information item to be used in combination to identify the device 21, or may include an information item other than the address 511 to be used to identify the device 21.

The communication parameter 51 is associated with one or more instance parameters 52. The instance parameter 52 is used to identify the method for data collection from the device 21 identified by the communication parameter 51. The instance parameter 52 includes a collection interval 521. The instance parameter 52 may include the collection interval 521 and another information item to be used in combination to identify the collection method, or may include an information item other than the collection interval 521 to be used to identify the collection method. Data from the device 21 may be collected at different intervals in parallel. In this case, multiple instance parameters 52 are specified for one communication parameter 51.

The instance parameter 52 is associated with one or more data parameters 53. The data parameter 53 is used to identify data to be collected from the device 21 identified by the communication parameter 51 and to be collected with the collection method identified by the instance parameter 52. The data parameter 53 includes a data name 531 for collection target data, a location parameter 532 indicating the location of the data in the device 21, and a data type 533 indicating the type of the data. Multiple datasets may be collected from the device 21 with the same collection method. In this case, multiple data parameters 53 are specified for one instance parameter 52. The data name 531 is any user-specified name. The location parameter 532 indicates, for example, the address of a memory in the device 21. The data type 533 is, for example, int or double.

Referring back to FIG. 4, the process controller 143 outputs data acquired from any processing unit 130 or the collector 160 to any processing unit 130 or the collector 160 in accordance with the setting of the process sequence. For example, the process controller 143 reads setting information from the storage 142 and specifies a parameter for data collection for an implementer 164 in the collector 160. The process controller 143 thus causes the collector 160 to collect data from the device 21 at specified intervals. The process controller 143 acquires from the collector 160 data collected from the device 21 by the collector 160, and outputs the data to the processing unit 131 to cause the processing unit 131 to perform a subprocess. The process controller 143 also acquires data indicating the result of a subprocess from a processing unit 130 and outputs the data to this or another processing unit 130 to cause the processing unit 130 to perform the next subprocess.

When acquiring data indicating the result of a subprocess from the processing unit 133, the process controller 143 outputs the data to the collector 160 as a control instruction to be transmitted to the device 22. The process controller 143 then specifies parameters for the collector 160 to cause the collector 160 to output a control instruction for the device 22. In some embodiments, the output set as an output of the process sequence is different from transmission of the control instruction. The process controller 143 then performs a process for implementing the defined output. For example, the process sequence may be defined to display its result on the screen. The process controller 143 may then output data through the process setting unit 141 for causing the input device 101 to display the result.

When an event occurs during implementation of the process sequence, typically an error, a communication failure, or missing values in data regularly collected, the process controller 143 writes identification information for identifying the event onto the storage 142. The identification information is an ID or a code corresponding to the type of the event. For example, when a failure occurs in communication with the device 21, the process controller 143 acquires the identification information 0001 from the implementer 164 and writes the information together with the time of the failure onto the storage 142. As shown in FIG. 5, the storage 142 accumulates identification information for identifying events as an event history 42. The process controller 143 corresponds to an example of control means for causing the processing units 130 and the collector 160 to perform subprocesses in the data collection apparatus 10.

The collector 160 is implemented mainly by the processor 11, the main memory 12, and the communicator 16 operating in cooperation, and performs the subprocesses 30 and 34. In detail, the collector 160 is implemented by the processor 11 running a software module stored in the auxiliary memory 13 in the same manner as the processing units 130. The software module may be plug-in software stored in the auxiliary memory 13 by the user. The plug-in software may be designed, purchased, or acquired as open-source software by the user. In FIG. 4, the single collector 160 is connected to both the devices 21 and 22. In some embodiments, different collectors 160 may be connected for different types of industrial networks connected to the data collection apparatus 10. The collector 160 corresponds to an example of collection means for collecting data in the data collection apparatus 10.

The collector 160 includes a configuration information provider 161 for providing configuration information for creating a parameter input screen to the process setting unit 141, a specific information provider 162 for providing information specific to the collector 160 to the process setting unit 141, a determiner 163 for determining whether a parameter received by the process setting unit 141 satisfies a predetermined condition, the implementer 164 for performing a subprocess, an event information provider 165 for providing, to the process setting unit 141, event information about an event occurring during implementation of the subprocess performed by the implementer 164, and a storage 166 for storing various items of data.

The configuration information provider 161 outputs configuration information to the process setting unit 141 upon receiving a request from the process setting unit 141. The specific information provider 162 outputs specific information to the process setting unit 141 upon receiving a request from the process setting unit 141. The specific information indicates, for example, the developer of the collector 160 and the version of the software module for implementing the collector 160.

The determiner 163 acquires a parameter received by the process setting unit 141 and determines whether the parameter satisfies a condition. For example, the determiner 163 determines whether an IP address as a parameter indicating the data collection target conforms to the IP address rule. In detail, the determiner 163 may receive a 33-bit IP address as a parameter from the process setting unit 141, although Internet Protocol version 4 (IPv4) uses a 32-bit IP address. The determiner 163 then provides, to the process setting unit 141, a determination result indicating that the parameter does not satisfy the condition. The determiner 163 may receive a 32-bit IP address as a parameter from the process setting unit 141. The determiner 163 then provides, to the process setting unit 141, a determination result indicating that the parameter satisfies the condition.

The determination as to whether the parameter satisfies a condition may be performed for multiple parameters, instead of a single parameter. In detail, the determiner 163 may determine whether a condition among multiple parameters is satisfied. For example, when a first parameter has a value less than a predetermined threshold, the determiner 163 may determine whether a second parameter has a value within a first range. When the first parameter has a value equal to or greater than the threshold, the determiner 163 may determine whether the second parameter has a value within a second range other than the first range.

The implementer 164 performs the subprocesses 30 and 34 as instructed by the process controller 143. In detail, the implementer 164 outputs information repeatedly acquired from the device 21 to the implementation controller 140 as controlled by the process controller 143. The implementer 164 then receives a control instruction output from the implementation controller 140 and transmits the control instruction to the device 22.

Upon receiving a request from the process setting unit 141, the event information provider 165 provides, to the process setting unit 141, event information corresponding to identification information included in the request. The event information includes, for example, the name and the details of an event. The user refers to the event information using the input device 101 to know the status of a process sequence during or after implementation of the process sequence.

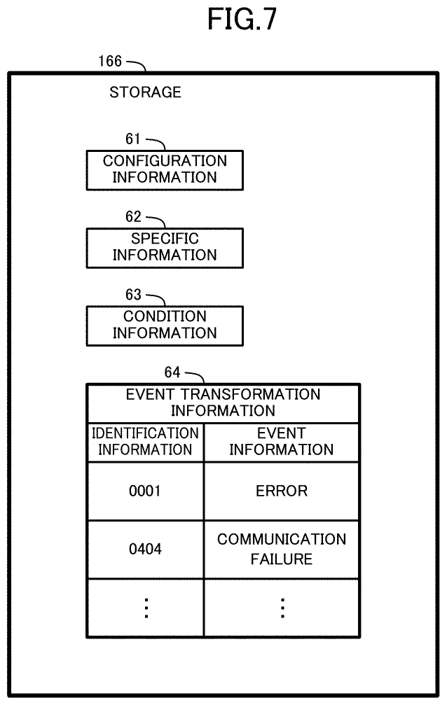

As shown in FIG. 7, the storage 166 stores configuration information 61 provided by the configuration information provider 161, specific information 62 provided by the specific information provider 162, condition information 63 indicating the condition to be used by the determiner 163 for determining a parameter, and event transformation information 64 used to associate event identification information and event information with each other. The information stored in the storage 166 may be prestored in the software module for implementing the collector 160, or may be externally acquired by running the software module. For example, the condition information may be acquired from the device 21 as a data collection target through a network, or may be information from the device 21 with modification.

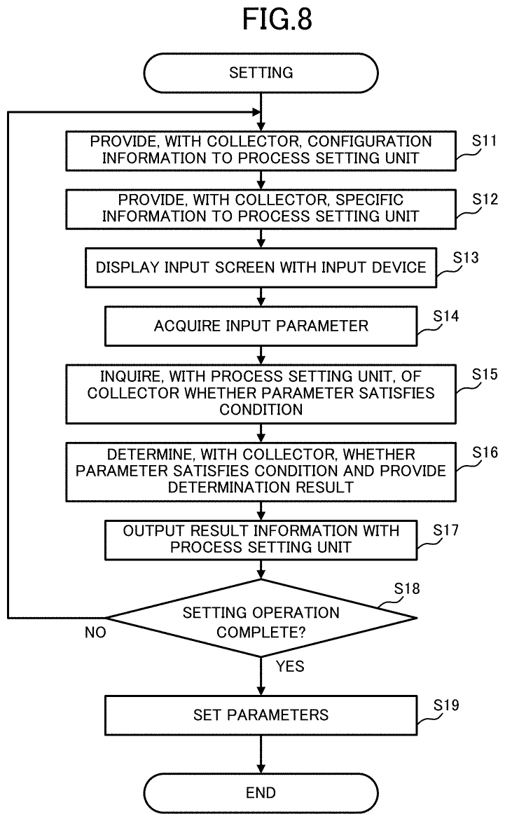

The process to be performed by the data collection apparatus 10 will now be described with reference to FIGS. 8 to 18. A typical procedure to be performed by the data collection apparatus 10 starts with setting of a process sequence including setting of data collection offline. Offline herein refers to before implementation of the process sequence is started, or in other words, while the process sequence is stopped. Upon completion of the setting, the data collection apparatus 10 becomes online with the process sequence starting. Whether offline or online, the user can acquire, from the input device 101, event information corresponding to identification information stored online. The processes described below are setting of a parameter received by the data collection apparatus 10, process implementation for implementing a process sequence in accordance with the set parameter, and event information display for notifying the user of an event occurring during implementation of the process sequence. These processes are described in this order.

FIG. 8 shows the details of the setting. The setting starts with the data collection apparatus 10 being notified that the input device 101 has received input of a user instruction for starting setting of a parameter. In the setting, the collector 160 provides configuration information to the process setting unit 141 (step S11). More specifically, the configuration information provider 161 reads configuration information from the storage 166 to provide the configuration information to the process setting unit 141. The process setting unit 141 may write configuration information partly or entirely onto the storage 142. The process setting unit 141 may then acquire the configuration information from the storage 142 in the next and subsequent setting. Rather than performing step S11, the process setting unit 141 may acquire an initial value of configuration information from the storage 142, and then acquire configuration information from the configuration information provider 161 as appropriate.

The collector 160 then provides specific information to the process setting unit 141 (step S12). More specifically, the specific information provider 162 reads, upon receiving a request from the process setting unit 141, specific information from the storage 166 and provides the specific information to the process setting unit 141.

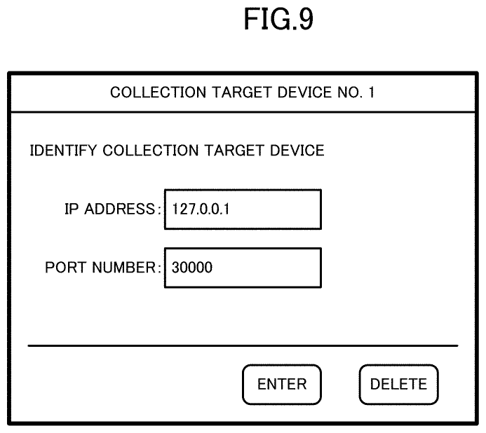

The input device 101 then displays an input screen using the configuration information provided in step S11 and the specific information provided in step S12 (step S13). For example, the input device 101 displays an input screen shown in FIG. 9. The input screen shown in FIG. 9 receives an IP address and a port number as communication parameters for identifying the device 21 as a data collection target.

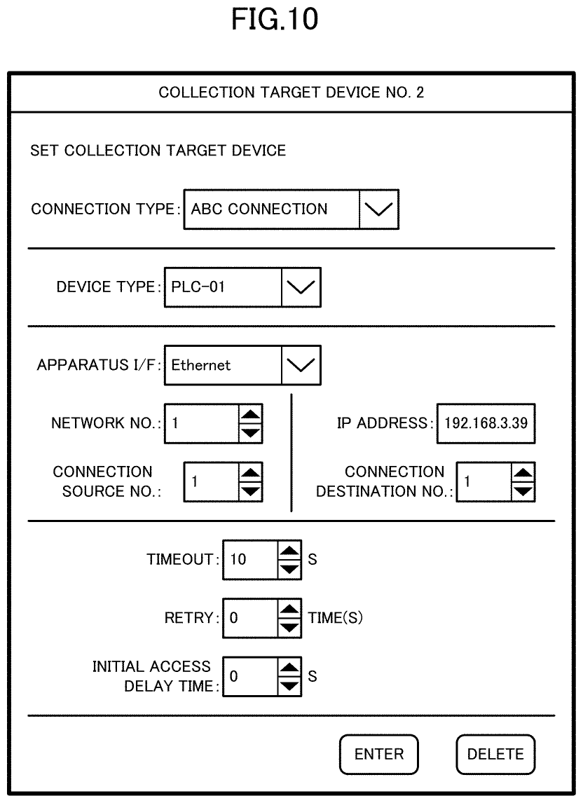

The input device 101 may display an input screen shown in FIG. 10. The input screen shown in FIG. 10 receives, as communication parameters, the type of connection between the data collection apparatus and the device 21 as a data collection target, the device type, the interface on the apparatus, the network number, the IP address of the device 21, the connection source number, and the connection destination number. This input screen receives input of a timeout, the number of retries during disconnection, and the initial access delay time each selected from multiple candidates. These parameters selected and input may be either communication parameters or instance parameters. In other words, the input screen may receive input of parameters in different hierarchies shown in FIG. 6.

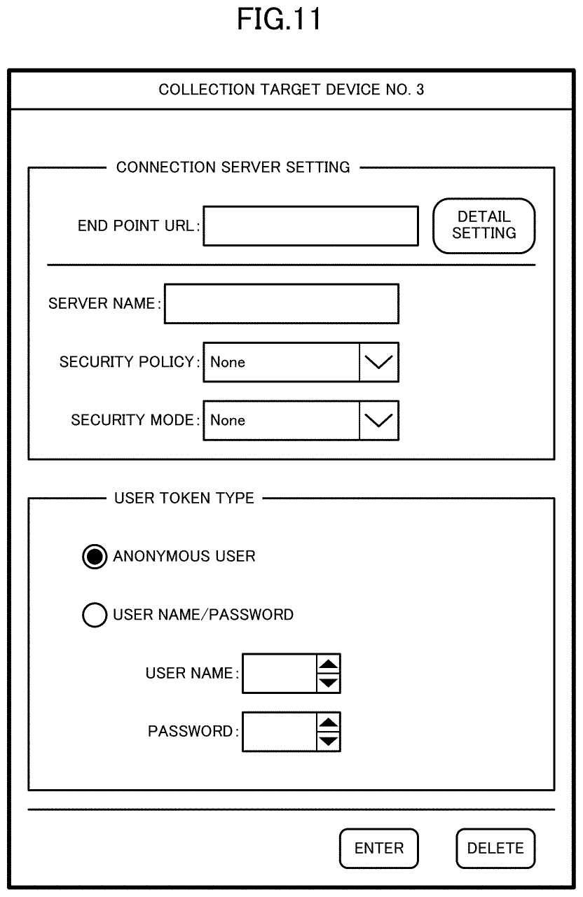

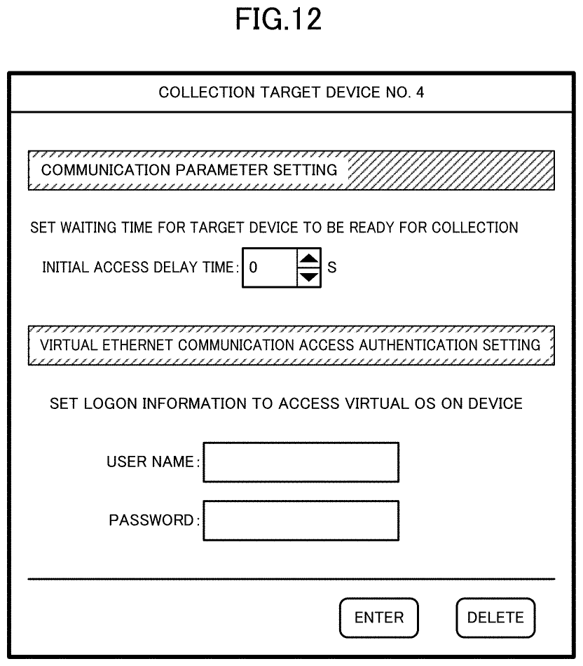

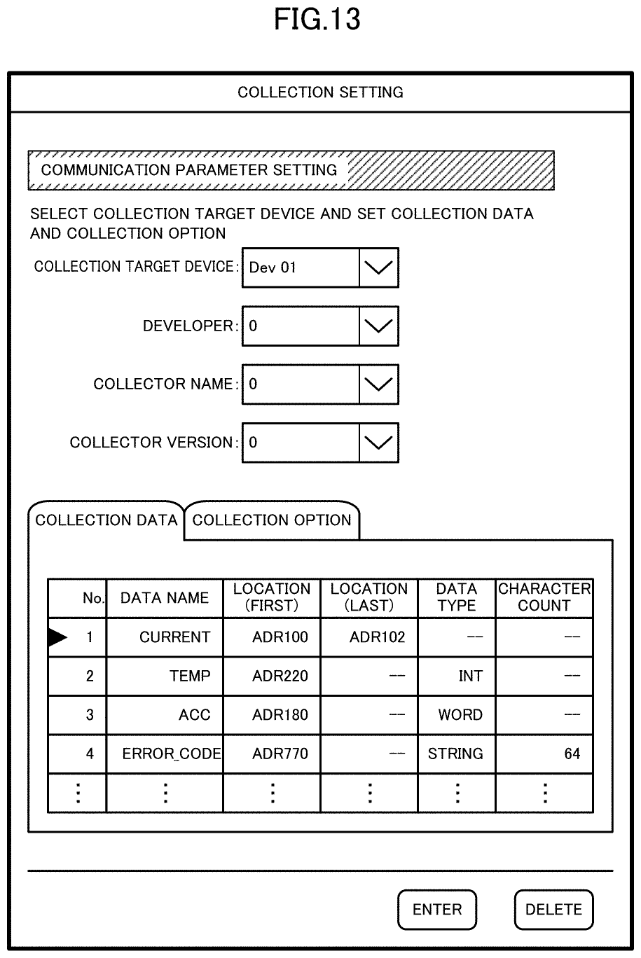

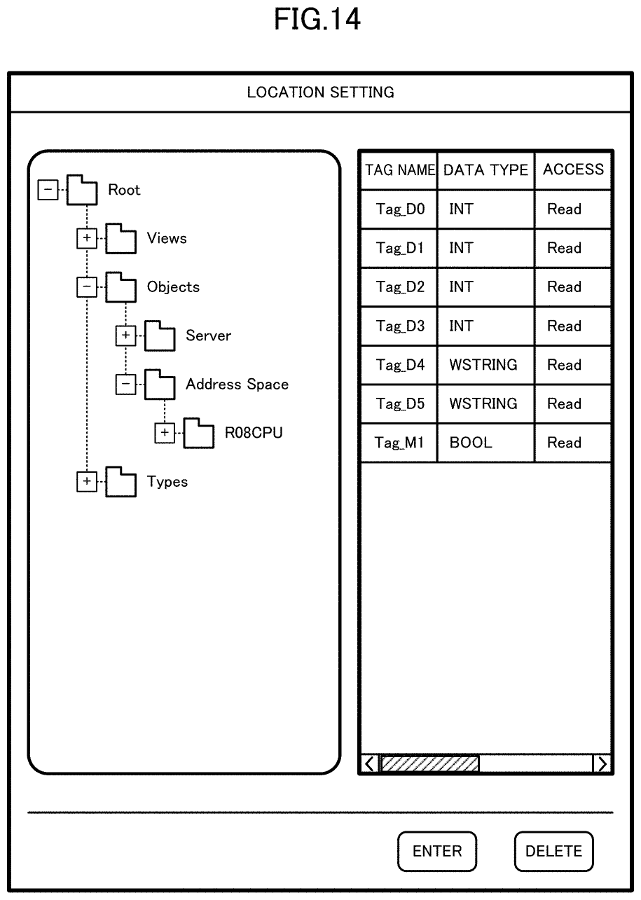

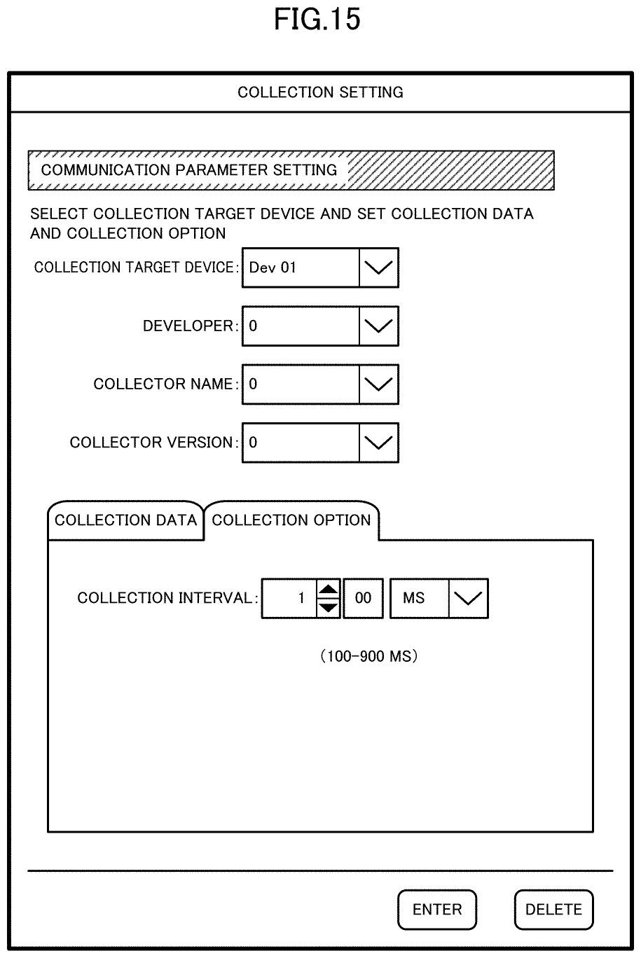

In some embodiments, the input device 101 may display an input screen for receiving communication parameters as shown in FIGS. 11 and 12. In some embodiments, the input device 101 may display an input screen for receiving communication parameters, instance parameters, and data parameters as shown in FIGS. 13 to 15. The input screen shown in FIG. 13 displays a table including input fields for receiving data parameters in the lower area selected with a tab. An input screen shown in FIG. 14 may appear upon selection of an input field for receiving a data location. The input screen shown in FIG. 14 displays data to be used by the device 21 in a tree format. The input screen shown in FIG. 15 displays input fields for receiving instance parameters in the lower area selected with a tab.

When the user touches the OK button at the bottom of the input screens illustrated in FIGS. 9 to 15, the input parameters are provided to the data collection apparatus 10. The user operation for completing the setting is not limited to touching the button. In some embodiments, the parameters may be provided to the data collection apparatus 10 upon activation of any window other than the parameter setting window.

Referring back to FIG. 8, following step S13, the data collection apparatus 10 acquires the parameter input by the user (step S14). More specifically, the process setting unit 141 receives the parameter from the input device 101.

The process setting unit 141 then inquires of the collector 160 whether the parameter acquired in step S13 satisfies a predetermined condition (step S15). For example, the process setting unit 141 outputs the input value of the collection interval on the input screen shown in FIG. 15 to the collector 160.

The collector 160 then determines whether the parameter inquired in step S15 satisfies a condition and provides the determination result to the process setting unit 141 (step S16). For example, the collector 160 determines whether the input value of the collection interval shown in FIG. 15 is within the range of 100 to 900.

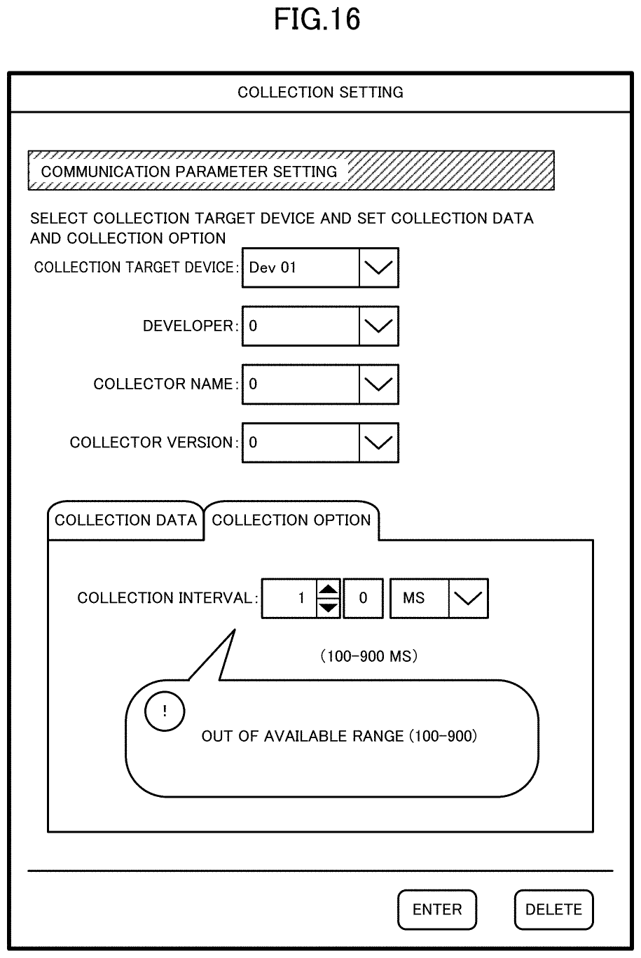

The process setting unit 141 then outputs result information corresponding to the determination result provided in step S16 (step S17). More specifically, when the parameter does not satisfy the condition, the process setting unit 141 transmits result information indicating an error in the input value to the input device 101. This causes a message to appear for prompting the user to re-input a parameter as illustrated in FIG. 16. The user then inputs a valid parameter. The result information may be output together with information indicating the condition to be satisfied by the parameter. In this case, the user is presented with the details of the condition output together with the result information. The user can thus correctly re-input a parameter that satisfies the condition.

Referring back to FIG. 8, following step S17, the data collection apparatus 10 determines whether the setting operation performed by the user is complete (step S18). More specifically, the process setting unit 141 determines whether all the valid values have been received as parameters to be set for the collector 160.

When determining that the setting operation is not complete (No in step S18), the data collection apparatus 10 repeats the processing in step S11 and subsequent steps. When determining that the setting operation is complete (Yes in step S18), the data collection apparatus 10 sets the parameters (step S19). More specifically, the process setting unit 141 writes setting information including the received parameters onto the storage 142. The setting then ends.

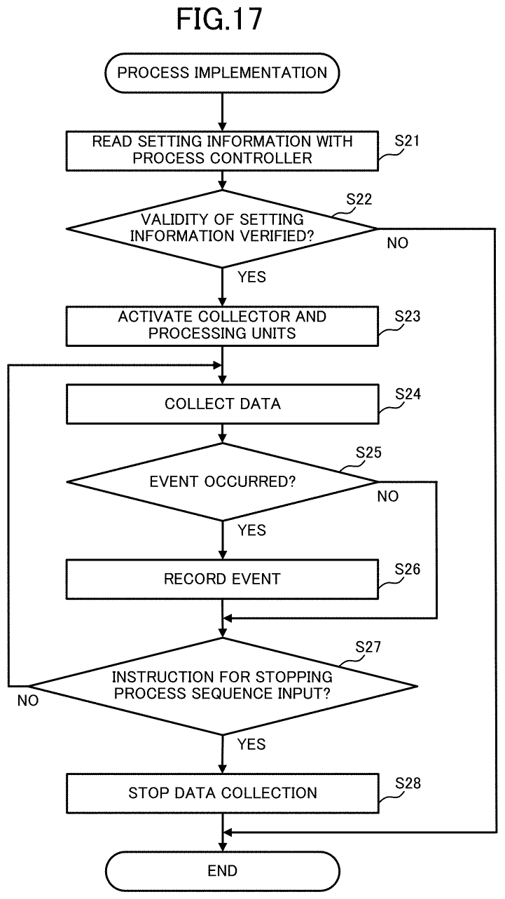

The process implementation will now be described with reference to FIG. 17. In the process implementation, the process controller 143 reads setting information from the storage 142 (step S21), and verifies the validity of the setting information (step S22). More specifically, the process controller 143 calculates the redundant code of the collector 160, and compares this redundant code with the redundant code in specific information acquired from the specific information provider 162 and incorporated in setting information in the setting. The redundant code of the collector 160 is calculated using a formula predefined by binary data in the software module for implementing the collector 160. The process controller 143 also determines whether the collector 160 is implementable based on the compatibility information acquired from the specific information provider 162.

When the validity of the setting information is not verified (No in step S22), the process implementation ends without performing a process sequence. When the validity of the setting information is verified (Yes in step S22), the process controller 143 activates the collector 160 and the processing units 130 (step S23). More specifically, the process controller 143 runs the software module for implementing the collector 160 and the processing units 130 that perform the subprocesses included in the set process sequence. This causes the process sequence to start.

When the process sequence starts, the implementer 164 in the collector 160 collects data from the device 21 as a collection target in accordance with the parameters included in the setting information (step S24). The implementer 164 also determines whether a predetermined event, typically an error, has occurred (step S25).

When the implementer 164 determines that an event has not occurred (No in step S25), the data collection apparatus 10 advances to step S27. When determining that the event has occurred (Yes in step S25), the implementer 164 provides the identification information of the event to the process controller 143. The process controller 143 then adds the identification information and the current time to the history to record the event (step S26).

The data collection apparatus 10 then determines whether an instruction has been input for stopping the process sequence (step S27). More specifically, the process controller 143 determines whether a user instruction for stopping the process sequence has been input through the input device 101 and the process setting unit 141.

When determining that an instruction has not been input (No in step S27), the data collection apparatus 10 repeats the processing in step S24 and subsequent steps. When determining that the instruction has been input (Yes in step S27), the data collection apparatus 10 stops data collection (step S28). More specifically, the process controller 143 stops the operation of the processing units 130 and the collector 160 to stop the process sequence. The process implementation then ends.

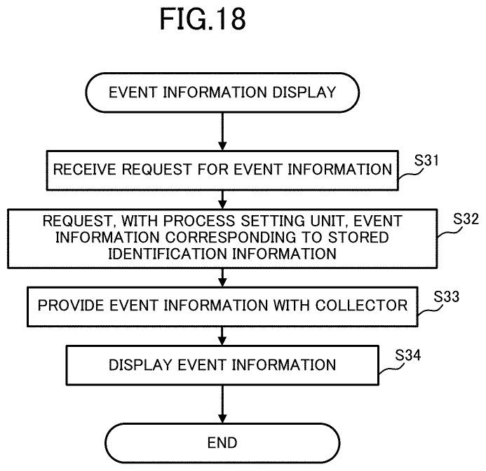

The event information display will now be described with reference to FIG. 18. The event information display starts with the input device 101 displaying a screen for providing event information to the user. In the event information display, the process setting unit 141 receives a request for event information from the input device 101 (step S31).

The process setting unit 141 then requests the collector 160 to provide event information corresponding to identification information stored in the storage 142 (step S32). Upon receiving the request, the collector 160 provides event information about the event indicated by the identification information to the process setting unit 141 (step S33). The event information includes the name and the details of an event, and optionally a message for handling an error.

The process setting unit 141 outputs, to the input device 101, the event information provided in step S33 together with the identification information and the event time. The input device 101 then displays the event information (step S34). The event information display then ends.

As described above, the collector 160 for collecting data from a network determines whether a parameter satisfies a predetermined condition and provides the determination result to the process setting unit 141. The process setting unit 141 then outputs result information corresponding to the determination result. Thus, the process setting unit 141 receiving the parameter outputs result information based on the determination result without determining whether the parameter satisfies the condition. When any new network is added as a data collection target, the collector 160 is changed or added for the new network without the process setting unit 141 being changed. This reduces the workload for incorporating a parameter setting function into the data collection apparatus 10. In other words, the data collection apparatus 10 can easily incorporate the function of collecting data from a new collection target.

When a parameter does not satisfy a condition, the collector 160 provides the determination result to the process setting unit 141. The process setting unit 141 then outputs, to the input device 101, result information corresponding to the determination result indicating that the parameter does not satisfy the condition. Thus, the input device 101 can notify, to the user, that the parameter does not satisfy the condition to allow the user to re-input a parameter that satisfies the condition.

The process setting unit 141 outputs, to the input device 101, condition information indicating the condition to be satisfied by the parameter together with result information. Thus, the input device 101 can present the condition to the user to allow the user to correctly input a parameter that satisfies the condition. The process setting unit 141 may acquire the condition information from the collector 160 or from a device external to the data collection apparatus 10. The condition information may be included in the result information.

The storage 142 stores identification information for identifying an event occurring in data collection. The collector 160 provides event information about the event indicated by the identification information to the process setting unit 141. The process setting unit 141 outputs the provided event information. The process setting unit 141 thus avoids accessing event information indicating the details of an event during implementation of a process sequence. The process setting unit 141 also avoids preparing event information about an event occurring in data collection with the collector 160, because such event information is provided by the collector 160.

Although the embodiments of the present disclosure have been described above, the present disclosure is not limited to the above embodiments.

In the above embodiments, the process setting unit 141 outputs, to the input device 101, result information prompting re-input of a parameter when the received parameter does not satisfy the condition. However, any other result information may be output. In some embodiments, upon receiving a determination result indicating that the received parameter does not satisfy the condition, the process setting unit 141 may change the parameter to a value satisfying the condition, incorporate the resultant value into setting information to generate result information, and write the result information onto the storage 142. Changing the parameter to satisfy the condition saves time and the effort of the user for re-inputting a parameter.

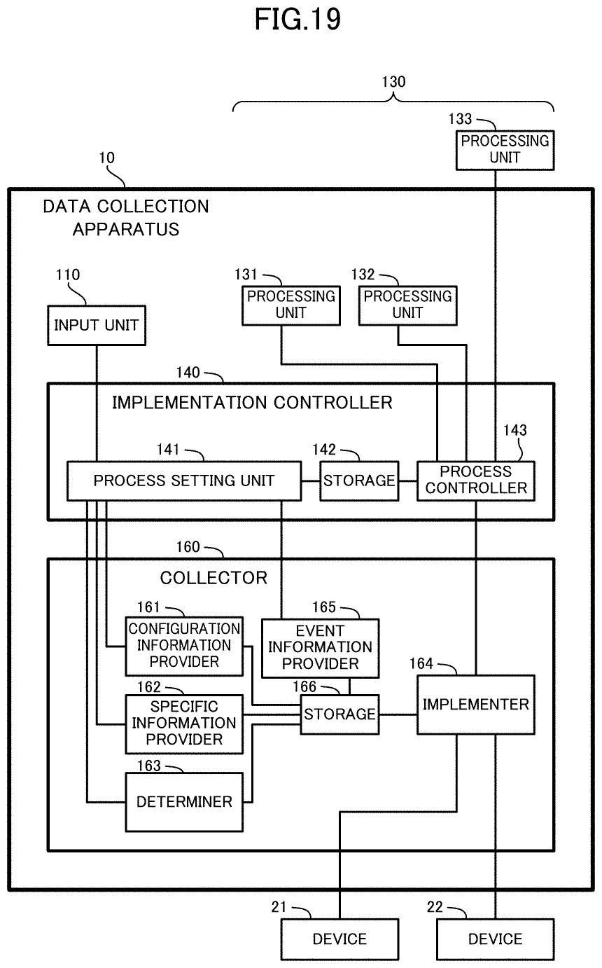

In the above embodiments, the data collection apparatus 10 is connected to the devices 21 and 22 through the industrial network 20. However, these components may have any other form of connection. In some embodiments, the network 20 may be an information network, and the data collection apparatus 10 may be connected to the devices 21 and 22 with a dedicated line. In the above embodiments, the data collection apparatus 10 is connected to the input device 101. The connection may use a network cable, a dedicated line, or the network 20. Instead of being connected to the input device 101, the data collection apparatus 10 may include an input unit 110 for receiving input of information from the user, as shown in FIG. 19. The data processing system 100 may further include a processing unit 133 external to the data collection apparatus 10.

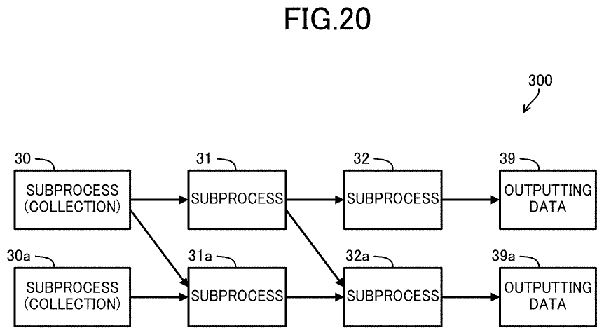

In the above embodiments, the process sequence is relatively simple as shown in FIG. 3. In some embodiments, the process sequence may be more complicated. As shown in the example in FIG. 20, the process sequence may have the subprocess 30 branching into subprocesses 31 and 31a that then join into a subprocess 32a.

The functions of the data collection apparatus 10 can be implementable by dedicated hardware or a common computer system.

For example, the program P1 executable by the processor 11 may be stored in a non-transitory computer-readable recording medium for distribution. The program P1 is installed in a computer to provide a device that performs the above processing. Examples of such non-transitory recording media include a flexible disk, a compact disc read-only memory (CD-ROM), a digital versatile disc (DVD), and a magneto-optical (MO) disk.

The program P1 may be stored in a disk unit included in a server on a communication network, typically the Internet, and may be, for example, superimposed on a carrier wave to be downloaded to a computer.

The processing described above may also be performed by the program P1 being activated and executed while being transferred through a communication network.

The processing described above may also be performed by the program P1 being entirely or partially executed on a server with a computer transmitting and receiving information about the processing through a communication network and executing a program.

In the system with the above functions implementable partly by the operating system (OS) or through cooperation between the OS and applications, portions executable by applications other than the OS may be stored in a non-transitory recording medium that may be distributed or may be downloaded to a computer.

Means for implementing the functions of the data collection apparatus 10 is not limited to software. The functions may be partly or entirely implemented by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The technique according to the present disclosure is suitable for data collection.

### REFERENCE SIGNS LIST

100 Data processing system
10 Data collection apparatus
11 Processor
12 Main memory
13 Auxiliary memory
14 Input unit
15 Output unit
16 Communicator
17Internal bus
20 Network
21 and 22 Device
300 Process sequence
30 to 34, 31a, and 32a Subprocess
41 Setting information
411 Parameter
42 Event history
51 Communication parameter
52 Instance parameter
53 Data parameter
511 Address
521 Collection interval
531 Data name
532 Location parameter
533 Data type
61 Configuration information
62 Specific information
63 Condition information
64 Event transformation information
101 Input device
110 Input unit
130 to 133 Processing unit
140 Implementation controller
141 Process setting unit
142 Storage
143 Process controller
160 Collector
161 Configuration information provider
162 Specific information provider
163 Determiner
164 Implementer
165 Event information provider
166 Storage
P1 Program

1. A data collection apparatus connectable to a device, the apparatus comprising:
a setter to receive and set setting values of parameters for data collection from the device;
a collector to collect data from the device in accordance with the setting values of the parameters set by the setter; and
a controller to output the data collected by the collector to a processing unit to cause the processing unit to process the data, wherein
the parameters include a communication parameter to identify the device, an instance parameter to identify a method for data collection from the device, and a data parameter to identify an address of a memory of the device in which the collected data is stored and a data type of the data, and the parameters are defined such that the communication parameter is associated with the one or more instance parameters and the instance parameter is associated with the one or more data parameters,
the collector is implemented by a software module,
the collector provides, to the setter, configuration information that creates an input screen for the parameters, the configuration information being prestored in the software module,
the collector determines whether the setting values of the parameters input by a user to the input screen and received by the setter satisfy a condition indicated by condition information that is information prestored in the software module or information externally acquired by running the software module to determine whether the condition among the setting values of the parameters is satisfied, and provides a determination result to the setter, and
the setter outputs result information corresponding to the determination result provided by the collector.

2. The data collection apparatus according to claim 1, wherein
when the setting values of the parameters do not satisfy the condition, the collector provides the determination result to the setter, and
the setter receives the setting values of the parameters input into an inputter and outputs the result information to the inputter.

3. The data collection apparatus according to claim 2, wherein
the setter outputs, together with the result information, the condition information indicating the condition to the inputter.

4. The data collection apparatus according to claim 1, wherein
when the setting values of the parameters do not satisfy the condition, the collector provides the determination result to the setter, and
upon receiving the determination result, the setter changes the setting values of the parameters to values satisfying the condition and sets the values as the result information.

5. The data collection apparatus according to claim 1, further comprising:
a storage to store identification information for identifying an event occurring in data collection performed by the collector, wherein
the collector provides, to the setter, event information about the event indicated by the identification information, and
the setter outputs the event information provided by the collector.

6. A data collection method comprising:
providing, by a collector implemented by a software module, configuration information that creates an input screen for parameters to a setter, the configuration information being prestored in the software module;
receiving and setting, by the setter, setting values of the parameters a for data collection from a device;
determining, by a collector, whether the setting values of the parameters input by a user to the input screen and received in the receiving and setting satisfies a condition indicated by condition information that is information prestored in the software module or information externally acquired by running the software module to determine whether the condition among the setting values of the parameters is satisfied, and providing, by the collector, a determination result to the setter;
outputting, by the setter, result information corresponding to the determination result provided by the collector in the determining and providing;
collecting, by the collector, data from the device in accordance with the parameters set in the receiving and setting; and
outputting, by a controller, the data collected in the collecting to a processing unit to cause the processing unit to process the data, wherein
the parameters include a communication parameter to identify the device, an instance parameter to identify a method for data collection from the device, and a data parameter to identify an address of a memory of the device in which the collected data is stored and a data type of the data, and the parameters are defined such that the communication parameter is associated with the one or more instance parameters and the instance parameter is associated with the one or more data parameters.

7. A non-transitory computer-readable recording medium storing a program, the program causing a computer connectable to a device to function as
a setter to receive and set setting values of parameters for data collection from the device,
a collector to collect data from the device in accordance with the setting values of the parameters set by the setter, and
a controller to output the data collected by the collector to a processing unit to cause the processing unit to process the data, wherein
the parameters include a communication parameter to identify the device, an instance parameter to identify a method for data collection from the device, and a data parameter to identify an address of a memory of the device in which the collected data is stored and a data type of the data, and the parameters are defined such that the communication parameter is associated with the one or more instance parameters and the instance parameter is associated with the one or more data parameters,
the collector is implemented by a software module,
the collector provides, to the setter, configuration information that creates an input screen for the parameters, the configuration information being prestored in the software module,
the collector determines whether the setting values of the parameters input by a user to the input screen and received by the setter satisfy a condition indicated by condition information that is information prestored in the software module or information externally acquired by running the software module to determine whether the condition among the setting values of the parameters is satisfied, and provides a determination result to the setter, and
the setter outputs result information corresponding to the determination result provided by the collector.
